(19) United States
(12) Patent Application Publication
(10) Pub. No.: US 2004/0078483 A1
(43) Pub. Date: Apr. 22, 2004

(54) System and method for implementing virtual loopbacks in ethernet switching elements

(76) Inventors: Raymond Simila, Portland, OR (US); Martin Lee, Tigard, OR (US); Stephen Charles Rose, Albuquerque, NM (US)

Correspondence Address: RAYMOND SIMILA, 4041 N. OVERLOOK BLVD., PORTLAND, OR, 97227, US

(21) Appl. No.: 10/683,607

(22) Filed: Oct. 9, 2003

Related U.S. Application Data
(60) Provisional application No. 60/418,946, filed on Oct. 16, 2002.

(51) Int. Cl. G06F 15/173

(52) U.S. Cl. 709/238

(57) ABSTRACT

System and method for implementing a virtual loopback feature within an Ethernet switching network which operates only on specified virtual circuits. The virtual loopback is implemented by the interception of frames belonging to a given virtual circuit and rewriting the source and destination MAC addresses such that the frame will be sent to a different port within the network.

### CROSS-REFERENCE TO RELATED APPLICATIONS

This application claims the benefit of PPA Ser. No. 60/418,946 filed 2002 Oct. 16, by the present inventors

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the methods and procedures for looping Ethernet virtual circuits within Ethernet switches in an Ethernet-based telecommunications system.

2. Discussion of Prior Art

A major concern for service providers is network downtime. In pursuit of 99.999% network availability, service providers must minimize network outages due to hardware, software, or facility failures. After a failure within a digital network has occurred, isolating the location of the failure and dispatching repair personnel to correct the problem are critical factors that affect the mean time to repair.

Operators of digital networks often use maintenance features in network equipment to sectionalize problems and avoid false dispatches. One of the most common maintenance features in digital networks is the loopback feature. The loopback feature allows the network operator to send a signal towards the destination and have that signal returned to the source at predefined locations within the network. Problems with equipment and facilities can be functionally isolated or sectionalized to locations before or after the loopback.

Current implementations of the loopback feature loop electrical signals at network interfaces by directly connecting the output of a port to the input of the same port, thus returning the loopback message to the sender. However, in connection-less networks, such as those based on Ethernet and/or internet protocol (IP), the loopback has been avoided because the connection-less nature of these networks renders the traditional loopback useless. Since Ethernet frames are switched based on source and destination media access control (MAC) addresses within the frame header at every switch, if these frames are simply sent back to the port from which they came, the loopback will not work as the frame will simply bounce back and forth, alternately being sent backwards and then moving forwards to reach the original destination. Inventions such as U.S. Pat. No. 6,052,362, Somer, address Ethernet testing through the switching logic of a specific device. This method works fine as long as a person and a tester are at the location of the device under test, and can disrupt all operating signals long enough to perform the test. However, this clearly is not a viable option for in-service equipment or within a network of Ethernet switches where direct physical access is not possible or practical.

U.S. Pat. No. 6,370,146, Higgins et al. describes a method wherein packetized data is looped back at nodes on either side of a network node that is to be added to the network. In this manner, data does not reach a section of the network that is down. This invention does not prove useful however, in cases where not all of the packetized traffic needs to be looped back. In other words, in Higgins et al., all data entering one of the loopback points gets switched back in the direction of its source. When adding a node, this feature may be useful, but in many cases, including those of isolating a network failure, this feature will be detrimental.

In TDM networks, this problem is solved with U.S. Pat. No. 4,860,281, Finley et al. Finley describes how to loop back only certain channels within a larger signal (e.g. a certain timeslot within a DS-1). However, this is only possible in synchronous circuit-switched networks where each signal has a defined path from source to destination and a defined timeslot system whereby an individual channel can be located. For packet-based networks with no defined paths or timeslots, such a method is not possible.

Clearly, the prior art lacks a workable solution to achieve a loopback in a connection-less network which will operate not on physical connections, but on virtual connections. Since within an Ethernet switch, customer signals are all mixed together, each customer circuit is a virtual circuit as defined by the source/destination addresses in the data frames. Operating a traditional loopback would cause all of the virtual circuits to be looped back toward their origination point; their destination addresses, however, would prevent them from reaching their origination point.

### OBJECTS AND ADVANTAGES

To address the problem stated above, a virtual loopback for Ethernet switched networks is required. This would allow a single virtual circuit to be looped at switching points in an Ethernet switched network. Accordingly, several objects and advantages of the present Patent Application of Simila et al. for “System and Method for Implementing Virtual Loopbacks In Ethernet Switching Elements” are:

1. to provide an Ethernet virtual loopback which will allow a single of flow of data, or virtual circuit, as defined by a source/destination MAC address pair, to be looped back to another port within the switched network (e.g. the source port) from a switching point within an Ethernet switched network without the disruption of all virtual circuits within the switching element and/or on the given port.

2. to overcome the endless loop problem wherein an Ethernet frame would simply bounce back and forth if a traditional loopback were implemented within an Ethernet switching element.

3. to allow testing features to be embedded within the network itself, thereby eliminating the need for external equipment as with current Ethernet networks.

4. to allow for the identification of the loopback source. At the point of loopback, the switch that implements the virtual loopback substitutes the source MAC address with its own MAC address, thereby identifying the point of the loopback.

Further objects and advantages include:

a) the ability of loopback messages to travel in-band or out-of-band and traverse islands of other types of equipment and/or vendors without having to establish communication with the island's network management system (NMS).

b) to obviate the need to establish a loopback wherein physical relays are switched where all flows, regardless of their source or destination addresses, are disrupted from their normal paths and Ethernet network will not properly route the frames back to their proper loopback locations.

c) to allow virtual circuits not included in a virtual loopback to continue unaffected by the virtual loopback condition.

d) to introduce methods for isolating and sectionalizing physical or non-physical faults at layer 2, thus obviating the need to rely on time-consuming layer 3 management to eventually route traffic around the fault via router table convergence.

Still further objects and advantages will become apparent from a consideration of the ensuing description and drawings.

### SUMMARY

To address the problem stated above, a virtual loopback for Ethernet switched networks is required. This Patent Application of Raymond Simila et al. for “System and Method for Implementing Virtual Loopbacks In Ethernet Switching Elements” allows for a useful virtual loopback feature to be implemented in an Ethernet-switching environment. The virtual loopback allows a single virtual circuit to be looped at switching points in an Ethernet switched network. Frames arriving at the loopback point have their destination MAC address changed to another MAC address, thus allowing the switching elements to send the frame back to another port for testing. The address translation is performed within the switching table itself, so that only the identified virtual circuits undergo loopback. This method of loopback addresses the endless loop problem by substituting the destination MAC address with a new destination MAC address which allows the switched network to route the frames to another port within the newtork.

In accordance with the present invention, the following definitions are made:

(1) Virtual Circuit—Ethernet frames that possess both the same source MAC address and destination MAC address.

(2) Virtual Loopback—The process whereby Ethernet frames belonging to a specific Ethernet virtual circuit have their header data rewritten so that they may be sent to another port within the network.

### DRAWINGS—FIGURES

Note that all figures depict the preferred embodiment only.

FIG. 1 shows a standard Ethernet frame.

FIG. 2 shows an example of an Ethernet switched network with two Ethernet Switch Transport Network Elements, and the interfaces and components they possess

FIG. 3 shows the example network of FIG. 2, but now with representations of the virtual circuits flowing within the network under normal conditions.

FIG. 4 shows a flow diagram of the virtual loopback setup process and the messages exchanged.

FIG. 5 shows a flow diagram of the virtual loopback operational process.

FIG. 6 shows the example network of FIG. 2, but now with representations of the virtual circuits flowing within the network under a virtual loopback condition.

FIG. 7 shows a flow diagram of the virtual loopback release process and the messages exchanged.

### DRAWINGS—REFERENCE NUMERALS

In the reference numerals, items of the same type have the same number, and a prime (′) after the number indicates a different physical instance of the item.

20—Ethernet Frame

22—Ethernet Frame Preamble

24—Ethernet Frame Destination MAC Address

26—Ethernet Frame Source MAC Address

28—Ethernet Frame Type

30—Ethernet Frame Data

32—Ethernet Frame CRC

34, 34′—Ethernet Switch Network Elements

36, 36′—Client Devices With Ethernet Interfaces

38, 38′—Ethernet Switch Matrices

40, 40′—Ethernet Switch Processors

42, 42′—Bidirectional Access From Processor From Switch Matrix and Data Communications Path

44—Transparent Communications Network

46—Physical Connection for Data Path

50—Data Communications Network

52, 52′—Data Communications Interfaces

54, 54′—Operations Support Interfaces

56—Unique Client MAC Address

58, 58′, 60, 60′, 62, 62′, 64, 64′, 66, 66′—Bidirectional Switch Transceiver Ports

68—Unique Switch Processor MAC Address

70—Unique Switch Processor MAC Address

72—Unique Client MAC Address

74—Flow From MAC Address 56 to MAC Address 72

76—Flow From MAC Address 72 to MAC Address 56

78—Looped-back Flow

80—Optional Duplicate Flow Data or ICMP Warning Message

100—User query for Virtual Circuit Path

102—Local Switch Iteratively Queries Network for Virtual Circuit Path

104—User Sends OPERATE_VLOOPBACK Command

106—Local Switch Directs OPERATE_VLOOPBACK to Loopback Switch

108—Loopback Switch Determines if OPERATE_VLOOPBACK Can Be Completed

110—DENY Message Propagates to User

112—Switching Table Modified

114—COMPLD Message Propagates to User

116—ICMP Message Sent to Far End of Virtual Circuit

118—End Setup

120—Source Sends Frame Along Virtual Circuit

122—Frame Forwarded to Processor at Loopback Switch

124—Destination MAC Addresses Replaced

126—Source MAC Address Replaced

128—Processor Forwards Modified Frame Back to Loopback Switch Matrix

130—Frame Switched Back Through Network to Source

140—Timeout Timer Set?

142—Timeout Timer Expired?

144—User Requesting Virtual Loopback Release?

148—User Issues REMOVE_VLOOPBACK Message

150—Local Switch Forwards REMOVE_VLOOPBACK Message to Loopback Switch

152—Loopback Switch Determines if REMOVE_VLOOPBACK Can Be Completed

154—DENY Message Propagates to User

156—Switching Table Modified

158—COMPLD Message Propagates to User

160—ICMP Message Sent to Far End of Virtual Circuit

162—End Release

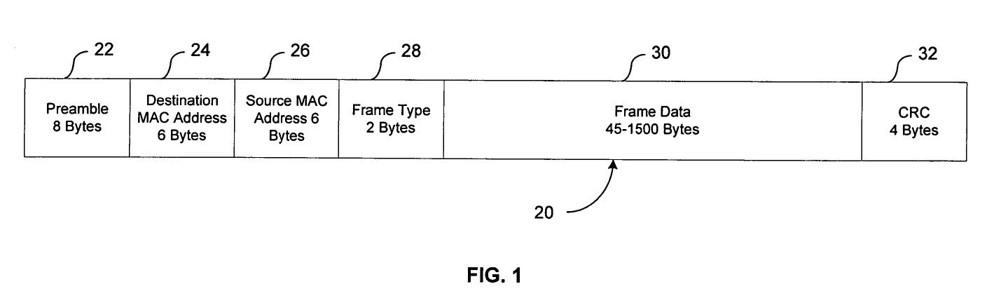

### DETAILED DESCRIPTION—FIGS. 1 THROUGH 7—PREFERRED EMBODIMENT

FIG. 1 shows the format of a standard Ethernet frame 20. Transmission proceeds from left to right starting with the preamble 22, followed by the destination MAC address 24, the source MAC address 26, the frame type 28, the frame data 30, and the error checking CRC 32.

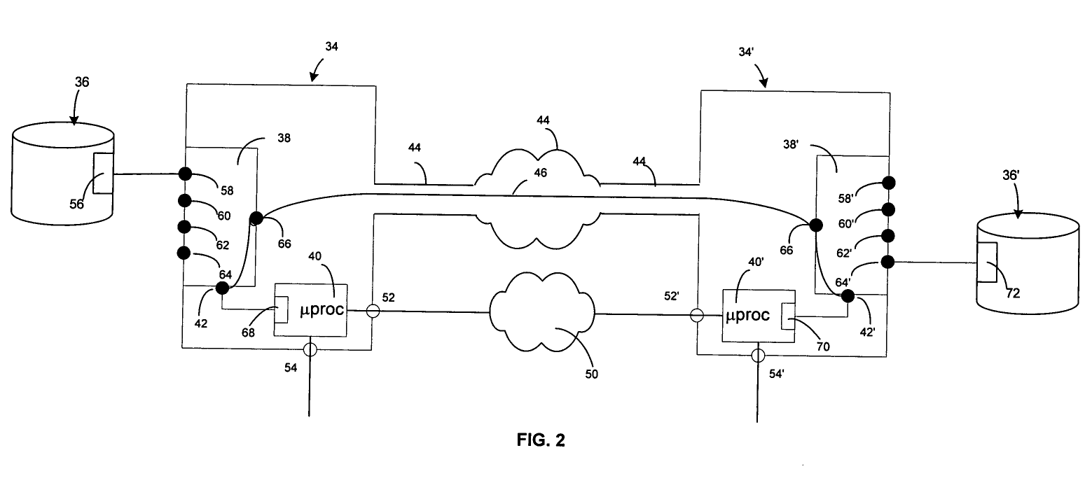

FIG. 2 shows a sample Ethernet switching network sufficient to describe the present invention. It should not be implied from FIG. 2 that any restrictions on any device, devices, network elements, or physical manifestations of hardware or networks are indicated or described. In this sample Ethernet switching network there are two Ethernet switching network elements, 34 and 34′, and two client devices 36 and 36′. The client devices 36 and 36′ should be understood to be any device or element that can connect properly to the network elements 34 and 34′. Such devices can include, but are not limited to, IP routers, other Ethernet switches, and test equipment. Each client device 36 and 36′ has its own globally unique MAC addresses, 56 and 72 respectively, which is used to uniquely identify each device on any network. The Ethernet switch network elements 34 and 34′ also possess globally unique MAC addresses, 68 and 70 respectively, which are associated with their processors, 40 and 40′, which control the network elements 34 and 34′.

As shown in FIG. 2, each network element 34 and 34′ contains an Ethernet switching matrix 38 and 38′, which consists of a plurality of bidirectional Ethernet transceiver ports 58, 58′, 60, 60′, 62, 62′, 64, 64′, 66, and 66′. In all figures, the number of bidirectional Ethernet transceiver ports shown in the switching matrices 38 and 38′ is for illustrative purposes only, and should not be interpreted as a limitation on the present invention. The processors 40 and 40′ also have bidirectional access to the switching matrices 38 and 38′ through their own dedicated ports 42 and 42′. These ports 42 and 42′ give the processors the ability to intercept any traffic in the switch for any purpose, as well as the ability to communicate with each other across the data network, which is known as in-band communication.

Each network element 34 and 34′ also contains a plurality of other connections such as data communications interfaces 52 and 52′, and operations support interfaces 54 and 54′. These interfaces 52, 52′, 54, and 54′ are one method by which the network elements 34 and 34′ may communicate with one another and/or receive management commands.

Communications between processors 40 and 40′ is accomplished in-band by sending frames through the ports 68 and 70. In this method of communications the processor messages traverse the data path 46. The processors may also communicate out-of-band by sending information through the data communications interface 52 and 52′ and an external data communications network 50.

One method for out-of-band communications is to use either the line or section SONET data communication channels (DCCs) (not shown) from a SONET transmission system. SONET DCCs are digital data channels formed from overhead bytes in the SONET frame structure. With this method, each processor 40 and 40′ is directly connected to the SONET DCC, which allows the processors to talk directly to each other. Another method of out-of-band communications is to use an external data communications network. External communications can use any type of public or private data communications network.

Similarly, the connection between the network elements 34 and 34′ may pass through any kind of transparent communication network or any number of additional switching elements. This transparent network 44 is shown in FIG. 2, but it should be understood that its presence or absence is not a limitation of the present invention. The physical connection 46 (e.g. Ethernet cable) is also shown.

Operation of the present invention is implemented by sending commands through the operational support interface 54 and 54′. Loopback commands can be directed to the local device or forwarded distant switches via the processor-to-processor communications previously described.

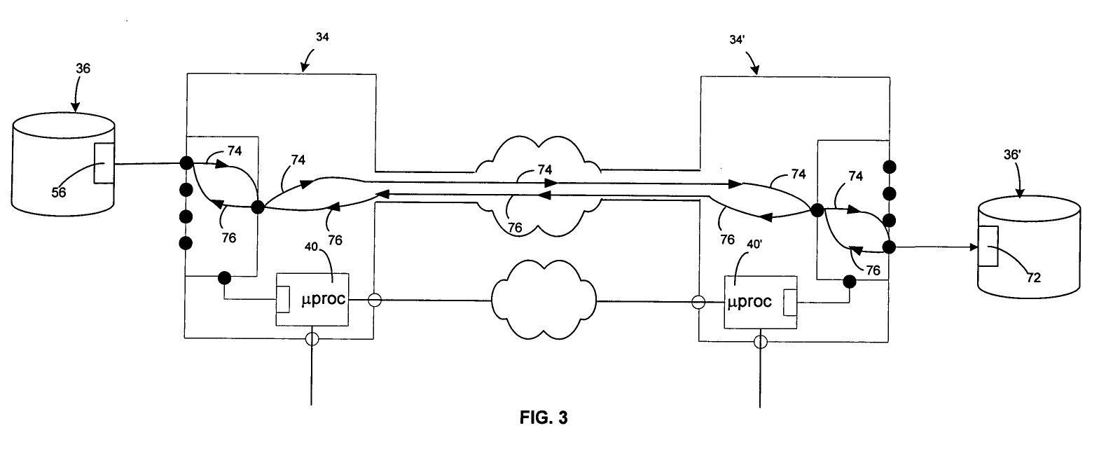

In any Ethernet network, a virtual circuit can be defined as the set of all Ethernet frames with a given source MAC address and destination MAC address. Since all MAC addresses are globally unique, each virtual circuit is unique as well. FIG. 3 shows a representation of the network from FIG. 2 with the virtual circuits/flows represented as arrowed lines. The virtual circuit flowing from client 36 to client 36′ is shows as the frame flow 74. The virtual circuit flowing from client 36′ to client 36 is shown as the frame flow 76. In normal operation, an Ethernet frame belonging to the virtual circuit 74 enters network element 34 from the source client 36 at bidirectional transceiver port 58. The frame is switched in the switch matrix 38 to the correct outgoing transceiver port 66. The frame enters network element 34′ at bidirectional port 66′, is switched in switch matrix 38′ to the correct outgoing port 64′ where the frame is sent to the destination client 36′.

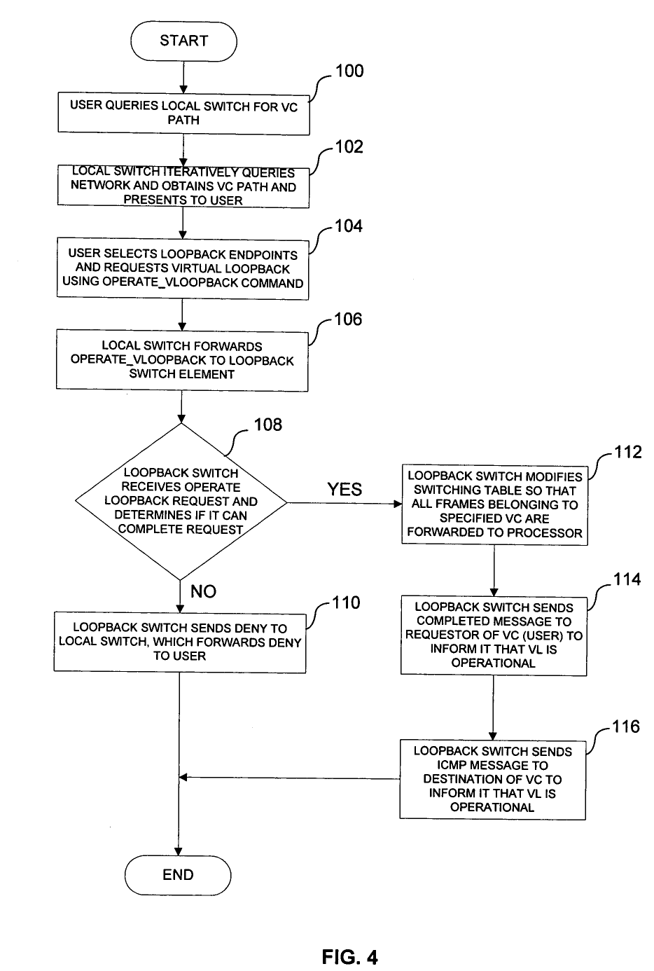

Under the present invention, a virtual loopback is requested with the process shown in FIG. 4. Since a virtual circuit traverses a set of network elements, the user must possess the list of such elements before deciding on a loopback point. If the user does not know the list of network elements a virtual circuit traverses, one may be requested by querying 100 the local switch 34 via one of the management ports 52 or 54 or by addressing the processor 40 via inband communications. The local switch processor 40 iteratively queries 102 successive network elements along the virtual circuit to determine the path through the network, and presents this information to the user in the following format:

Virtual_Circuit_ID(Source Address, Destination Address)

| | |
|---|---|
| Node_ID(Ingress Port, Egress Port) | [ingress switch node] |
| Node_ID(Ingress Port, Egress Port) | [second switch node] |
| . | |
| . | |
| . | |
| Node_ID(Ingress Port, Egress Port) | [egress switch node] |

where Virtual_Circuit_ID is an assigned identification to the virtual circuit defined by (Source Address, Destination Address), Node_ID is an identification of a specific Ethernet switch along the path of the virtual circuit, and Ingress/Egress Port is used by the processor 40 in tracing the path through the network. The user selects the loopback location and issues an OPERATE_VLOOPBACK command 104 to the local switch with the following message:

OPERATE_VLOOPBACK(NODE_ID, VIRTUAL_CIRCUIT_ID, DESTINATION_ADDRESS, TIMEOUT)

where NODE_ID is the Ethernet switch that is requested to become the switch at which the virtual loopback takes place, the loopback switch, DESTINATION_ADDRESS is the destination wher the looped packets are sent, and TIMEOUT is an optional value indicating that the virtual loopback should be automatically removed after a set amount of time. Either a user or a client device 36 may request a virtual loopback 104.

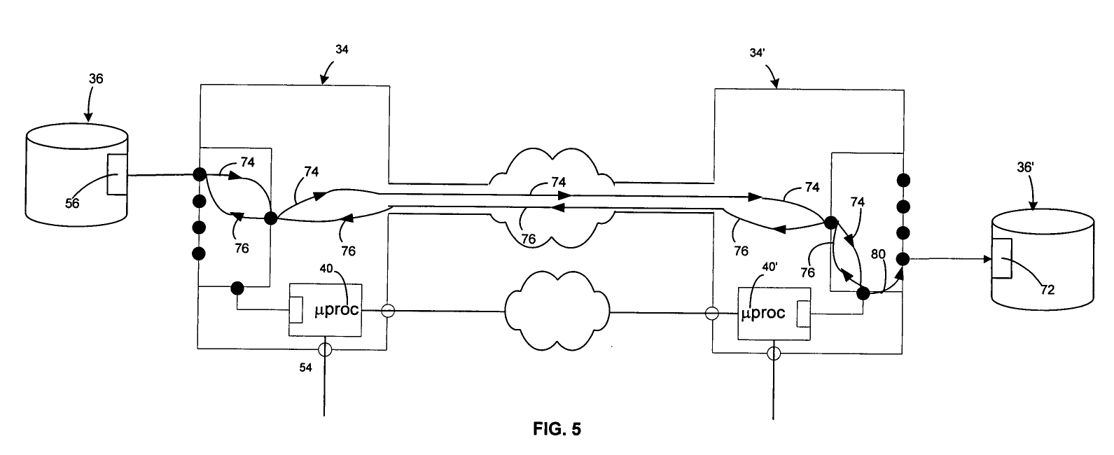

The processor 40 at the local switch 34 receives the OPERATE_VLOOPBACK command at operational support interface 40 and forwards 106 the command 104 to the loopback switch 34′ as determined by NODE_ID. When the command 104 reaches the loopback switch 34′, the loopback switch 34′ determines if the virtual loopback request can be processed 108. If the request cannot be processed, the loopback switch 34′ sends a DENY message 110 back to the local switch 34 where it is further forwarded to the user. If the request can be processed, the loopback switch 34′ modifies its switching table so that all frames belonging to the specified virtual circuit are forwarded 112 to the processor 40′, sends a COMPLETED message back to the originator of the request 114, and optionally sends an ICMP message 78 (shown in FIG. 5), to the virtual circuit's source 36 and/or destination 36′ client of the specified virtual circuit 116. The ICMP message is sent to inform both ends of the virtual circuit that a virtual loopback is in progress on one of the specified virtual circuits. This will prevent excessive alarming within and downstream from both clients 36 and 36′ when frames from virtual circuit 74 no longer arrive. This completes the virtual loopback setup process 118.

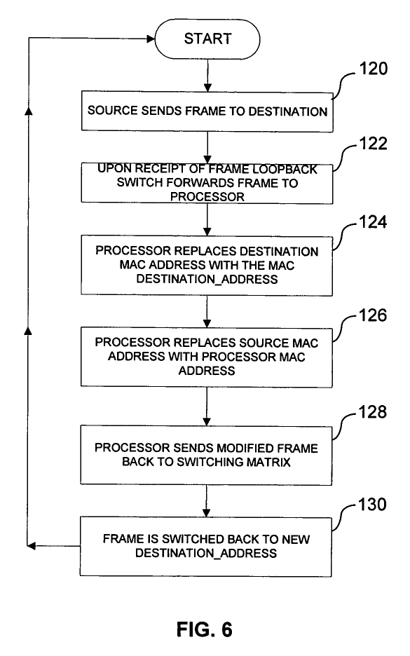

The operation of the virtual loopback process is shown in FIG. 5. The example network shown in FIG. 2 is now shown under the virtual loopback condition in FIG. 6. As before, the client device 36 sends frames 120 belonging to virtual circuit 74 to element 34 where they are switched ultimately to element 34′. When the loopback switch 34′ receives the frame, it now forwards the frame 122 to the processor 40′. The processor 40′ now changes 124 the destination MAC address of the frame to the DESTINATION_ADDRESS MAC address 56 of the frame. The processor 40′ then changes 126 the source MAC address of the frame to its own MAC address 70. The processor then sends 128 the modified frame back to the switching matrix 38′ from where the frame is ultimately switched 130 back through the network to the new loopback destination location. This becomes now the looped-back flow 80. This new virtual circuit 80 is the looped back data that will be used for testing.

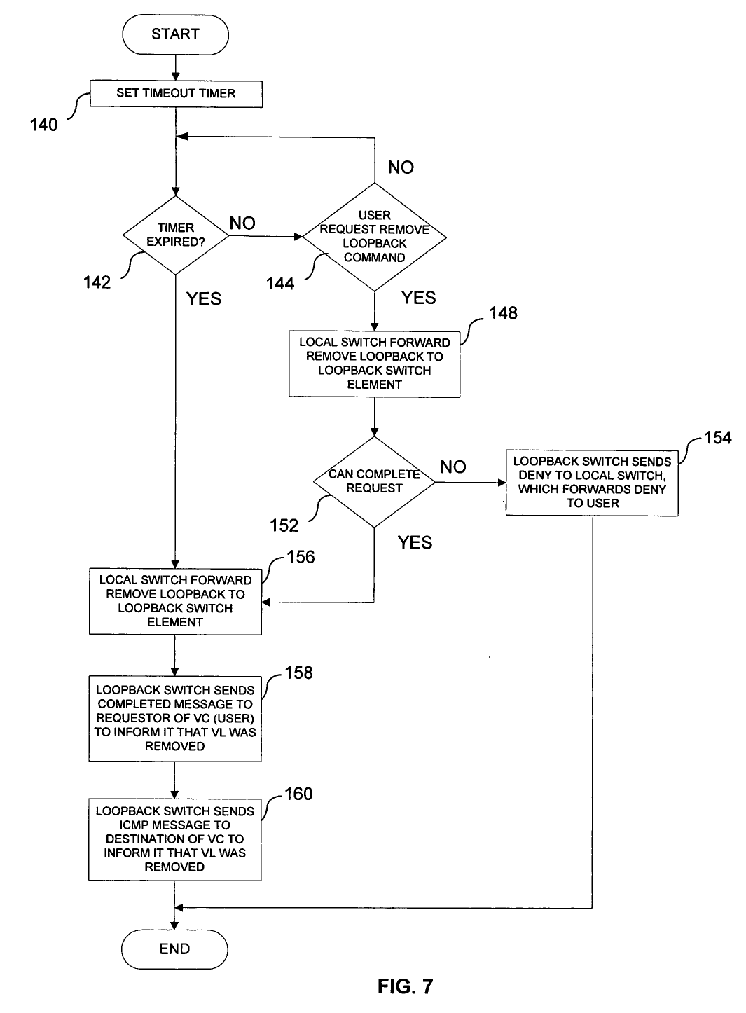

FIG. 7 shows the process whereby a virtual loopback may be removed. As shown earlier, virtual loopbacks may timeout on their own, 140 and 142, if a timeout timer was set. Regardless of whether a timeout timer was set, if specifically requested, a virtual loopback can be released at any time, 144 and 146, if requested by the client 36 or user. If this is the case, a RELEASE_LOOPBACK(Virtual_Circuit₁₃ ID) command is sent 148 to the local switch, which as before, forwards 150 the command to the loopback switch 34′. The loopback switch 34′ determines 152 if the virtual loopback can be removed and normal switching operation resumed. If the virtual loopback cannot be removed, the loopback switch issues 154 a DENY message which propagates back to the originator of the request. If the request can be completed, the loopback switch 34′ modifies 156 its switching table so that frames belonging to the virtual circuit are switched normally again, sends 158 a COMPLETED message to the request originator, and optionally sends 160 an ICMP message to the original destination 36′ of the virtual circuit to inform it that the virtual loopback has been released. This ends 162 the virtual loopback release process.

Conclusion, Ramifications, and Scope of Invention

Thus, the reader will see that the System and Method for Implementing Virtual Loopbacks In Ethernet Switching Elements described herein provides the desired virtual loopback functionality within an Ethernet switched network. The present invention solves two main problems encountered previously, namely the endless loop problem and the unintentional loopback of all virtual circuits traversing the network element. The present invention fills a marketplace need for fault isolation and sectionalization in Ethernet-switched networks where time presents a crucial constraint on network resources and carrier success.

While the above description contains many specificities, these should not be construed as limitations on the scope of the invention, but rather as an exemplification of one preferred embodiment thereof. For example:

(1) The ICMP-type messages sent by the loopback processor 40 to the far-end client 36′ are optional;

(2) The transparent communications network shown in FIG. 2 may be present in any form, or not at all;

(3) The Ethernet Switch Elements may possess any kind of operational interface, the ones shown are simply the most common;

(4) There may be timeout timers implemented for any part of the virtual loopback process which cause commands or command requests to timeout or expire;

(5) OPERATE_VLOOPBACK, and REMOVE_VLOOPBACK commands do not need to be sent by the devices involved in a particular virtual circuit. Any network-recognized authority can issue these commands.

(6) There may be status messages used to determine the status of a specific virtual loopback or virtual circuit.

(7) The loopback switch may inform the network that the state of the virtual circuit for which the virtual loopback is operating is out-of-service for management reasons network wide when the virtual loopback is setup.

(8) The loopback switch may inform the network that the state of the virtual circuit for which the virtual loopback has operated is in-service for management reasons network wide when the virtual loopback is removed.

(9) ICMP messages can use any agreed upon message to indicate the presence of the virtual loopback (e.g. “HOST UNREACHABLE”).

Accordingly, the scope of the invention should be determined not by the embodiment(s), but by the appended claims and their legal equivalents.

What is claimed:

1. A system of implementing a virtual loopback in Ethernet switching elements or Ethernet networks consisting of:
a. A virtual loopback setup process which selects the virtual circuit to be looped back, the Ethernet switch in the network at which the virtual loopback will take place, issuance of a request virtual loopback command, and issuance of acknowledgement messages by the loopback switch to inform the requester and the virtual circuit's source and/or destination of the outcome of the virtual loopback setup command request. If successful, the loopback switch modifies its switching table so that frames belonging to the specified virtual circuit are forwarded to the switch processor.
b. A virtual loopback operational process where frames are sent along a virtual circuit's normal path through the network, arrive at a loopback switch previously setup to loopback that virtual circuit, are forwarded to the switch processor, have their destination MAC address rewritten to a new MAC address used for testing, have their source MAC address rewritten as the switch processor's MAC address, and are sent back into the switching network.
c. A virtual loopback removal process where a remove virtual loopback command request is issued to the loopback switch, the issuance of acknowledgement messages by the loopback switch to inform the requester and the virtual circuit's source and/or destination of the outcome of the virtual loopback teardown command request. If successful, the loopback switch modifies its switching table so that frames belonging to the specified virtual circuit are forwarded normally, and no longer diverted to the switch processor.
whereby a virtual loopback sends frames to user-specified locations in the network.

2. The system of claim 1 wherein the information regarding the virtual circuit information and the loopback switch identification is obtained by the issuance of a path request command, which causes an iterative query of the network to determine a virtual circuit's path through the network.

3. The system of claim 1 wherein the virtual loopback setup request optionally specifies a timeout value which will cause the virtual loopback to be automatically released after a set amount of time.

4. The system of claim 1 wherein the virtual loopback setup command request specifies a virtual circuit identified by a network-determined virtual circuit ID.

5. The system of claim 1 wherein the virtual loopback setup command request specifies a loopback switch identified by a network-determined node ID.

6. The system of claim 1 wherein the acknowledgement messages to the source and/or destination of the virtual circuit takes the form of an ICMP message

7. The messages of claim 6 wherein the ICMP message conveyed is HOST UNREACHABLE for setup and teardown

8. The messages of claim 6 wherein the ICMP message conveyed is PORT UNREACHABLE for setup and teardown

9. The system of claim 1 wherein an operating virtual loopback will be automatically removed by the network if a timeout timer was specified in the virtual loopback setup, wherein the loopback switch itself or an external management system will automatically issue a remove virtual loopback command request.

10. The system of claim 1 wherein an operating virtual loopback can be removed at any time by a remove loopback command request.

11. A method for setting up a virtual loopback in Ethernet switching elements or Ethernet networks, comprising the following steps:
a. Sending a command to the loopback switch requesting a virtual loopback for a specific virtual circuit.
b. The loopback switch determining if it can implement the requested virtual loopback.
c. If the loopback switch cannot implement the virtual loopback request, it sends a denial message back to the requestor of the virtual loopback.
d. If the loopback switch can implement the virtual loopback, it modifies its switch table so that all frames belonging to the specified virtual circuit are switched to the switch processor, and then sends a setup completed message to the requester and a notification message to the source and/or destination of the virtual circuit.
wherein now a frame can successfully be sent to a new port.

12. The method of claim 11 wherein the request takes the form of OPERATE_VLOOPBACK(parameters).

13. The request of claim 12 wherein one parameter is the virtual circuit ID.

14. The request of claim 12 wherein one parameter is the node ID of the loopback switch.

15. The request of claim 12 wherein one parameter is the DESTINATION_ADDRESS within the network.

16. The request of claim 12 wherein one parameter is the virtual loopback timeout value.

17. The method of claim 11 wherein in order to determine the loopback node, the virtual loopback requestor first requests the list of nodes traversed through the network by a given virtual circuit, and the local switch performs this inquiry by iteratively querying successive nodes along the virtual circuit path, and then presents this information to the requestor.

18. The method of claim 11 wherein the message to the source and/or destination of the virtual circuit is an ICMP message.

19. The message of claim 17 wherein the ICMP message conveyed is HOST UNREACHABLE.

20. The message of claim 17 wherein the ICMP message conveyed is PORT UNREACHABLE.

21. A method for operating a virtual loopback in Ethernet switching elements or Ethernet networks comprising the following steps:
a. The source/originator sends a frame belonging to a specific virtual circuit along its normal path through the network.
b. When the frame reaches the loopback switch, the frame is diverted to the switch processor.
c. The switch processor rewrites the destination MAC address as the new DESTINATION_ADDRESS MAC address.
d. The switch processor rewrites the source MAC address as its MAC address.
e. The switch processor sends the modified frame back to the switching matrix where normal switching rules return the frame to the new DESTINATION_ADDRESS.
wherein frames are successfully sent to a new port.

22. The method of claim 20 wherein the virtual loopback process will timeout if a timeout parameter was specified in the virtual loopback setup.

23. The method of claim 20 wherein the virtual loopback can be manually removed at any time.

24. A method for removing a virtual loopback in Ethernet switching elements or Ethernet networks comprising the following steps:
a. At any time the removal of a virtual loopback may be requested by sending a remove virtual loopback command request the loopback switch. If a previously configured timeout timer expires, the loopback switch issues a remove virtual loopback command request to itself.
b. Upon receipt of a remove virtual loopback command request, the loopback switch determines if it can complete the request.
c. If the loopback switch cannot complete the remove virtual loopback request, it issues a denial to the requester.
d. If the loopback switch can complete the request it restores the switching table such that frames belonging to a given virtual circuit are forwarded normally and are no longer diverted to the switch processor, issues a removal completed message to the requester, and optionally issues a notification to the source and/or destination of the virtual circuit that the virtual loopback has been removed.
wherein a virtual loopback is now removed and no longer affects frame traffic

25. The method of claim 23 wherein the remove request takes the form REMOVE_VLOOPBACK(parameters).

26. The request of claim 24 wherein one parameter is the virtual circuit ID.

27. The method of claim 23 wherein the notification to the source and/or destination of the virtual circuit takes the form of an ICMP message.
